(19) United States
(12) Patent Application Publication
(10) Pub. No.: US 2024/0255907 A1
(43) Pub. Date: Aug. 1, 2024

(54) SYSTEMS AND METHODS FOR OPTIMAL ENERGY USE AND CARBON EMISSIONS USING HIERARCHICAL MODEL PREDICTIVE CONTROL (MPC)

(71) Applicant: Honeywell International Inc., Charlotte, NC (US)

(72) Inventors: Joseph MAJEWSKI, Huntington, NY (US); Ramdas PAI, Cary, NC (US); Joseph LU, Glendale, AZ (US)

(21) Appl. No.: 18/160,433

(22) Filed: Jan. 27, 2023

(51) Int. Cl. G05B 19/042; G06N 5/022

(52) U.S. Cl. CPC G05B 19/042; G06N 5/022; G05B 2219/2639

(57) ABSTRACT

A method for optimizing carbon emissions and/or energy usage of a site is disclosed comprising: obtaining a planning model for optimizing carbon emissions and/or energy usage of the site at a site-wide model predictive control (MPC) controller; sending at least one optimization request from the site-wide MPC controller to one or more unit MPC controllers; receiving at least one proxy limit value from the one or more unit MPC controllers at the site-wide MPC controller in response to the at least one optimization request, wherein the at least one proxy limit value identifies an extent to which one or more controlled variables controlled by the one or more unit MPC controllers are adjustable without violating one or more controlled variable constraints;

and performing site-wide optimization at the site-wide MPC controller using the planning model and the at least one proxy limit value.

### TECHNICAL FIELD

The present disclosure relates generally to carbon emissions reduction control and automation systems. More specifically, this disclosure relates to a cascaded model predictive control (MPC) approach for site-wide control and optimization of energy use and carbon emissions.

### BACKGROUND

Carbon emission reduction is increasing becoming a key aspect of sustainability goals for businesses of all sizes. Conventional solutions for carbon emissions reduction generally address tracking and reporting of energy use, and typically involve a human operator in the loop to reactively modify energy use parameters to reduce energy consumption. One major contribution to carbon emissions for many businesses is the energy expended to operate heating, ventilation and air conditioning (HVAC) systems to maintain a comfortable environment in buildings, campuses, warehouses, and other sites where occupants work and otherwise gather. In an enterprise that includes many sites, such as buildings, warehouses, campuses, and other facilities that may be spread out geographically, this often involves piecemeal mitigation at each site in response to awareness of energy use without an overarching optimization system in place. There exists a desire for a fully scalable, closed-loop, carbon emissions reduction offering for buildings, campuses, warehouses, and other sites within an enterprise.

This disclosure is directed to addressing the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for carbon emissions reduction control and automation systems.

In one aspect, an exemplary embodiment includes a computer-implemented method for optimizing carbon emissions and/or energy usage of a site comprising: obtaining a planning model for optimizing carbon emissions and/or energy usage of the site at a site-wide model predictive control (MPC) controller; sending at least one optimization request from the site-wide MPC controller to one or more unit MPC controllers; receiving at least one proxy limit value from the one or more unit MPC controllers at the site-wide MPC controller in response to the at least one optimization request, wherein the at least one proxy limit value identifies an extent to which one or more controlled variables controlled by the one or more unit MPC controllers are adjustable without violating one or more controlled variable constraints; and performing site-wide optimization at the site-wide MPC controller using the planning model and the at least one proxy limit value.

In a further aspect, a computer system is disclosed for optimizing carbon emissions and/or energy usage of a site, the computer system comprising: at least one memory having processor-readable instructions stored therein; and at least one processor configured to access the memory and execute the processor-readable instructions, which when executed by the at least one processor configured the processor to perform a plurality of functions, including functions for: obtaining a planning model for optimizing carbon emissions and/or energy usage of the site at a site-wide model predictive control (MPC) controller; sending at least one optimization request from the site-wide MPC controller to one or more unit MPC controllers; receiving at least one proxy limit value from the one or more unit MPC controllers at the site-wide MPC controller in response to the at least one optimization request, wherein the at least one proxy limit value identifies an extent to which one or more controlled variables controlled by the one or more unit MPC controllers are adjustable without violating one or more controlled variable constraints; and performing site-wide optimization at the site-wide MPC controller using the planning model and the at least one proxy limit value.

In another aspect, a non-transitory computer-readable medium is disclosed containing instructions for optimizing carbon emissions and/or energy usage of a site, the non-transitory computer-readable medium storing instructions that, when executed by at least one processor, configure the at least one processor to perform: obtaining a planning model for optimizing carbon emissions and/or energy usage of the site at a site-wide model predictive control (MPC) controller; sending at least one optimization request from the site-wide MPC controller to one or more unit MPC controllers; receiving at least one proxy limit value from the one or more unit MPC controllers at the site-wide MPC controller in response to the at least one optimization request, wherein the at least one proxy limit value identifies an extent to which one or more controlled variables controlled by the one or more unit MPC controllers are adjustable without violating one or more controlled variable constraints; and performing site-wide optimization at the site-wide MPC controller using the planning model and the at least one proxy limit value.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates an example carbon emission and energy use control system according to this disclosure.

FIGS. 2A and 2B illustrate an example cascaded MPC architecture for energy use control and optimization according to this disclosure.

FIG. 3 illustrates MPC control applied to the carbon emission and energy use optimization of a plurality of sites.

FIG. 4 provides an exemplary application of MPC control as applied to carbon emission and energy use optimization of a single site.

FIG. 5 depicts an example dynamic feasible region for use by a controller performing model predictive control of a nonlinear process according to this disclosure.

FIG. 6 depicts a flowchart of an exemplary method for optimizing carbon emissions and/or energy usage of a site, according to one or more embodiments.

FIG. 7 depicts an implementation of a controller that may execute techniques presented herein, according to one or more embodiments.

### DETAILED DESCRIPTION OF EMBODIMENTS

According to certain aspects of the disclosure, methods and systems are disclosed for carbon emissions reduction control and automation systems. More specifically, this disclosure relates to a cascaded, hierarchical model predictive control (MPC) approach for control and optimization of energy use and carbon emissions.

There exists a desire for a fully scalable, closed-loop, carbon emissions reduction offering for buildings, campuses, warehouses, and other sites where occupants work and gather. One major contribution to carbon emissions for many businesses the energy expended to operate heating, ventilation and air conditioning (HVAC) systems to maintain a comfortable environment in buildings, campuses, warehouses, and other sites where occupants work and otherwise gather. A solution is offered via hierarchical, cascaded model predictive control (MPC), in which multiple hierarchical layers are provided that perform different functions. For example, lower layers could include devices that perform process control functions and model predictive control (MPC) operations, while higher layers could include devices that provide enterprise-wide optimization solutions.

This disclosure provides a cascaded MPC solution for site-wide control and optimization of energy use, which helps to provide site-wide optimization as part of an automatic control and automation system. As described below, a “site-wide” MPC controller is configured to use a planning model, such as a single-period planning model or other suitable reduced model(s), as a seed model. The site-wide MPC controller performs site-wide energy use optimization using its optimizer to control carbon emissions and energy use. The site-wide MPC controller is cascaded on top of one or more unit MPC controllers. Each unit MPC controller provides the site-wide MPC controller with its operating states and constraints. Because of this, a site-wide optimization solution from the site-wide MPC controller can honor all operating constraints from the unit MPC controllers. Jointly, the MPC cascade simultaneously provides both decentralized controls (such as at the unit level) and centralized site-wide optimization (such as at the site-wide level) in a single consistent control system. The phrases “site-wide optimization” or “site-wide control” refers to optimization or control of multiple units in a given site, regardless of whether those multiple units represent every single unit in the site.

In this way, this MPC cascade solution enables embedded real-time planning solutions to honor lower-level operating constraints. By applying both planning and control models online, the MPC cascade solution makes it possible to run a closed-loop control system in real-time.

From a site-wide perspective, control and planning are coupled. Planning typically relies on control to establish a feasible region for optimization, while control typically relies on planning to coordinate units and run an entire site at its lowest possible carbon emissions. Planning therefore often depends on MPC controllers to push constraints inside each unit to create a bigger feasible region for site-wide optimization. Meanwhile, MPC controllers often depend on guidance from planning before the MPC controllers know which constraints are truly site-wide constraints and should thus be pushed and which constraints are not and could remain inactive. These two solution layers therefore co-depend on each other and should be treated simultaneously. Additional details regarding the operations of hierarchical MPC control can be found in U.S. Pat. No. 9,733,629 (which is hereby incorporated by reference in its entirety).

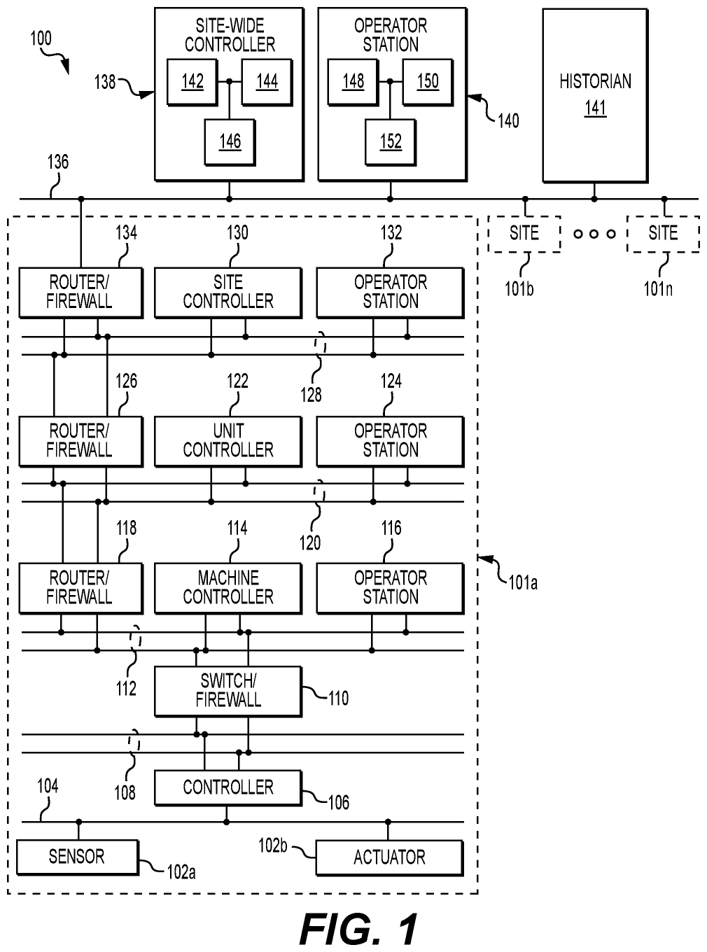

FIG. 1 illustrates an example carbon emission and energy use control system 100 according to this disclosure. As shown in FIG. 1, the system 100 includes various components that contribute to the energy consumption of a site 101a-101n. Each site 101a-101n represents one or more buildings, campuses, warehouses, or other sites (or one or more portions thereof).

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, humidity, air flow, etc. Also, the actuators 102b could alter a wide variety of characteristics in the system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network, a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller, or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks. At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which may be associated with a particular piece equipment (such as equipment in an HVAC system). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device. Although not shown, different machine-level controllers 114 could be used to control different pieces of equipment in a system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running an operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 2” may include one or more unit-level controllers 122 coupled to the networks 120. Each unit-level controller 122 is typically associated with a unit in a system, which represents a collection of different components operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of or operations related to one or more machines or other pieces of equipment in a process unit. Each of the unit-level controllers 122 could, for example, represent a server computing device running an operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running an operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more site-level controllers 130 coupled to the networks 138. Each site-level controller 130 is typically associated with one of the sites 101a-101n, which may include one or more process units that implement the same, similar, or different processes. The site-level controllers 130 perform various functions to support the operation and control of components in the lower levels. As particular examples, the site-level controller 130 could execute one or, scheduling applications, or other or additional process control applications. Each of the site-level controllers 130 includes any suitable structure for providing access to, control of or operations related to one or more process units in a system. Each of the site-level controllers 130 could, for example, represent a server computing device.

Access to the site-level controllers 130 may be provided by one or more operator stations 132. Each of the operator stations 132 includes any suitable structure for supporting user access and control of one or more components in the system 100. Each of the operator stations 132 could, for example, represent a computing device.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more site-wide controllers 138 coupled to the network 136. Each site-wide controller 138 is typically able to perform planning operations for multiple sites 101a-101n and to control various aspects of the sites 101a-101n. The site-wide controllers 138 can also perform various functions to support the operation and control of components in the sites 101a-101n. As particular examples, the site-wide controller 138 could execute one or more order processing applications, enterprise resource planning (ERP) applications, advanced planning and scheduling (APS) applications, or any other or additional enterprise control applications. Each of the site-wide controllers 138 includes any suitable structure for providing access to, control of, or operations related to the control of one or more sites. Each of the site-wide controllers 138 could, for example, represent a server computing device. Note that if a single site 101a is to be managed, the functionality of the site-wide controller 138 could be incorporated into the site-level controller 130.

Access to the site-wide controllers 138 may be provided by one or more operator stations 140. Each of the operator stations 140 includes any suitable structure for supporting user access and control of one or more components in the system 100. Each of the operator stations 140 could, for example, represent a computing device.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100. In particular embodiments, the various controllers and operator stations in FIG. 1 may represent computing devices. For example, each of the controllers 106, 114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116, 124, 132, 140 could include one or more processing devices 148 and one or more memories 150 for storing instructions and data used, generated, or collected by the processing device(s) 148. Each of the operator stations 116, 124, 132, 140 could also include at least one network interface 152, such as one or more Ethernet interfaces or wireless transceivers.

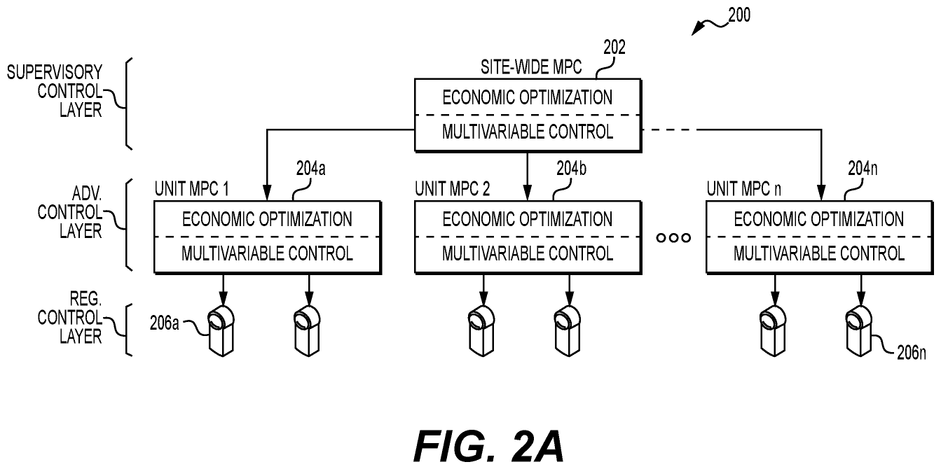

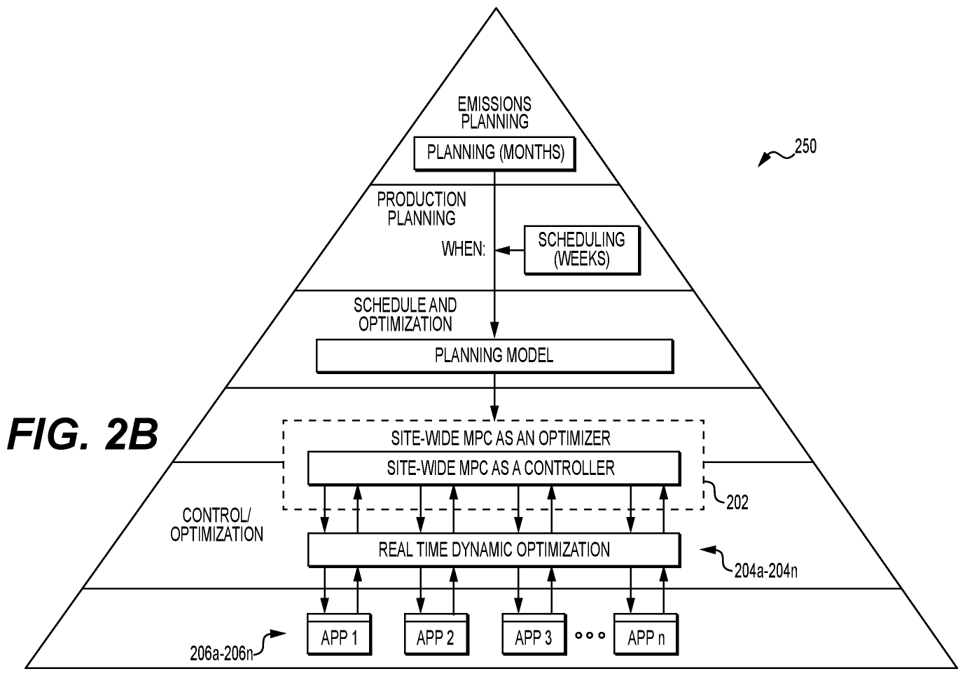

FIGS. 2A and 2B illustrate an example cascaded MPC architecture 200 for energy use control and optimization according to this disclosure. As shown in FIG. 2A, the cascaded architecture 200 includes a site-wide MPC controller 202 and one or more unit MPC controllers 204a-204n. The unit MPC controllers 204a-204n interact with one or more regular process controllers 206a-206n. The unit MPC controllers 204a-204n could denote Level 2 controllers, while the process controllers 206a-206n could denote Level 2 controllers.

In general, a planning model (FIG. 2B) looks at an entire site (or portion thereof) with a broad view and thus represents individual units on a coarse scale. A planning model may be constructed from a combination of various sources, such as planning tools, scheduling tools, and/or historical operating data. An MPC model 250, however, represents at least one unit on a finer scale. An MPC model 250 focuses on the intra-unit dynamic relationships between controlled variables (CVs), manipulated variables (MVs), and disturbance variables (DVs) pertaining to the safe, smooth, and efficient operation of a unit. The time scales of the two models are also different. An MPC model's time horizon typically ranges from minutes to hours, while a planning model's time horizon typically ranges from days to months. Note that a “controlled variable” (CV) generally denotes a variable whose value is controlled to be at or near a setpoint or within a desired range, while a “manipulated variable” (MV) generally denotes a variable that is adjusted in order to alter the value of at least one controlled variable. A “disturbance variable” (DV) generally denotes a variable whose value can be considered but not controlled or adjusted.

Each MPC controller 202, 204a-204n supports energy use optimization and multivariable control functions. The site-wide MPC controller 202 uses a planning model 200 (such as a yield-based single-period planning model) to provide an initial steady-state gain matrix, and relevant model dynamics can be determined using operating data of the site (such as historical data). The site-wide MPC controller 202 operates to control product inventories, manufacturing activities, or product qualities within the site. The embedded optimizer of the site-wide MPC controller 202, which is furnished with the same planning model structure and economics, could therefore reproduce the single-period offline planning optimization but in an online and real-time manner.

The site-wide MPC controller 202 cascades on top of n unit MPC controllers 204a-204n (n is an integer value greater than or equal to one). The unit MPC controllers 204a-204n provide the site-wide MPC controller 202 with future predictions and operating constraints for each component of a site. With this information, a real-time planning solution from the cascaded architecture 200 reduces or eliminates the drawbacks discussed above. Jointly, the MPC controllers 202, 204a-204n provide simultaneously decentralized controls at lower levels with fine-scale MPC models 250 and centralized site-wide optimization at higher levels with a coarse-scale planning model 200, all in one consistent cascaded control system.

One reason an energy use optimization plan often needs to be manually converted into a set of operating instructions is that an open-loop planning solution has a time horizon that typically ranges from several days to a week or more (for a single period), and it is commonly executed only once a day or once every several days. Thus, it lacks an effective feedback mechanism to deal with uncertainties, such as changes in ambient conditions, heating or cooling capacity limitations, and maintenance. In order to help deal with these situations, an optimizer is embedded in the site-wide MPC controller 202, and the optimizer can execute at a user-defined frequency, such as one ranging from once every several minutes to once an hour, among other time horizons. If any deviations from the original optimal plan are detected, a site-wide re-optimization can take place immediately. The new optimal targets can then be sent to and get carried out by the unit MPC controllers 204a-204n, reducing or eliminating the need for manual translation or adjustment.

The planning model used by the site-wide MPC controller 202 contains two parts, namely (i) a dynamic model for MPC control and (ii) a steady-state model for optimization (which is the steady-state part of the dynamic model). The site-wide MPC controller 202 reproduces the offline planning optimization as closely to the original plan as possible in real-time by leveraging MPC feedback to improve the accuracy of the offline planning optimization, thereby incorporating real-time information that was not available before. The dynamics of the site-wide MPC controller's model 200 can be identified from the site's operating data, and the site-wide MPC controller 202 can provide the desired controls in a closed-loop. Because the control and optimization solutions from the site-wide MPC controller 202 honor the operating constraints from the unit MPC controllers 204a-204n, this enables the site-wide MPC controller 202 to run in the closed-loop and makes the MPC cascade possible. This is done while providing both centralized compact site-level optimization and unit-level decentralized MPC controls.

The site-wide MPC controller 202 includes any suitable structure for performing economic optimization operations using a planning model. The site-wide MPC controller 202 could, for example, represent a single input single output (SISO) controller, a multiple input multiple output (MIMO) controller, or a controller with other numbers of inputs and outputs. Each unit MPC controller 204a-204n includes any suitable structure for interacting with a site-wide MPC controller. Each unit MPC controller 204a-204n could, for instance, represent a SISO controller, a MIMO controller, or a controller with other numbers of inputs and outputs.

The site-wide MPC controller 202 is an independent MPC controller using a planning model. In order for the site-wide MPC controller 202 to cascade over the unit MPC controllers 204a-204n, the site-wide MPC controller 202 honors the constraints of the unit controllers 204a-204n, or the overall combined solution may not be optimal or even feasible to implement. To help avoid this situation, a proxy limit is used to merge multiscale models. A proxy limit is an alternative representation of a unit MPC controller's constraint(s) in the site-wide MPC controller's space. Proxy limits can be viewed as conduits between individual unit MPC controllers and the site-wide MPC controller to “transport” the unit MPC controllers' constraints to the site-wide MPC controller. Proxy limits from multiple unit MPC controllers 204a-204n can be combined and included in the site-wide MPC controller's control and energy use optimization formulations.

Proxy limits can be expressed in the MV space of the site-wide MPC controller 202, but their boundary values can be computed in the MV space of the unit MPC controllers 204a-204n. For each MV of the site-wide MPC controller 202, each of its downstream unit MPC controllers can predict the amount of distance it could move before one or more unit CVs or MVs would reach their operating limits. When two or more MVs from the site-wide MPC controller 202 are associated with a unit MPC controller 204a-204n, the proxy limits can be multivariate in nature.

In each unit, regardless of how many unit constraints can limit a site-wide MPC controller's MV (such as the damper position), the site-wide MPC controller 202 only needs to know the point where it should stop pushing its MV (otherwise some lower-level constraint violation can result). This stopping point coincides with the proxy limit, which represents the entire set of active unit constraints in the corresponding low-level unit that can limit the site-wide MPC controller's MV.

One feature of proxy limits is that all unit MPC constraints in a unit can be distilled into one or several proxy limits. The proxy limits therefore function as a bonding mechanism for keeping the coarse-scale model 200 intact in the site-wide MPC controller 202 while merging it effectively with the fine-scale unit MPC models 250. In other words, this makes it possible to keep the site-wide optimization problem inside the site-wide MPC controller 202 in its original planning format without forcing the coarse-scale model 200 to be expanded into a compatible fine-scale model.

With the help of proxy limits, the joint optimization solution using the cascaded MPC approach provides various benefits. For example, the embedded real-time planning solution honors unit-level operating constraints in the unit MPC controllers 204a-204n, and the site-wide MPC controller 202 dynamically controls the same set of variables (such as temperature and humidity) that an offline planning tool would manage in open loop. Effectively, all relevant MPC constraints in a unit are distilled into one or more proxy limits, which in turn are included in the site-wide MPC controller's optimization. Moreover, proxy limits make the layered-optimization more attractive than a single layer. In addition, the practice of manual adjustment or translation of an open-loop optimization solution can be reduced or eliminated. By cross-leveraging both planning and control models online, the cascaded MPC approach makes it possible to run site-wide optimization within a closed-loop control system in real-time. It thus provides simultaneously a centralized optimization with a coarse-scale planning model 200 at the site level and decentralized controls with fine-scale MPC models 250 at the unit level.

Note that the concept of MPC cascading with proxy limits has been described as being performed with Level 2 MPC controllers as the unit controllers. However, this concept can be used with or extended to different levels of a control and automation system. For example, site-wide MPC controllers in multiple cascaded architectures 200 within a site could form unit MPC controllers for a site-level site-wide MPC controller. Multiple site-level site-wide MPC controllers could function as unit MPC controllers to an site-wide site-wide MPC controller.

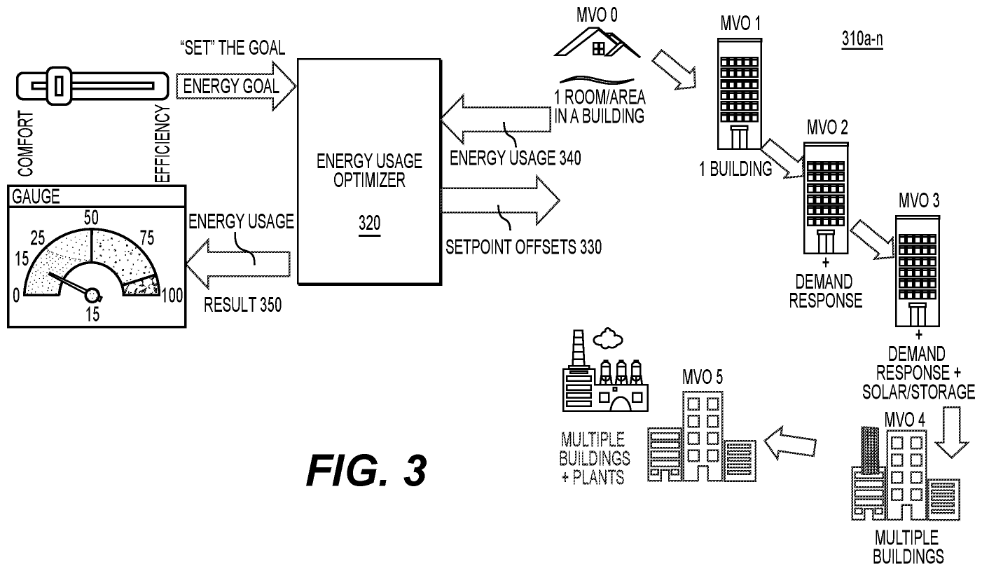

FIG. 3 illustrates MPC control applied to the carbon emission and energy use optimization of a plurality of sites 310a-310n within an enterprise, with particular attention paid to the energy use required for HVAC. As used herein, a “site” may be any unit within an enterprise from a single room/area within a building (MVO 0) to multiple buildings and sites (MVO 5).

Energy use optimization in the field of HVAC often requires a tradeoff between comfort and efficiency. Energy usage optimizer 320 is tasked with finding the optimum balance of these two within the constraints described below to arrive as the energy usage results set out by the planning model 200. Optimal heating, ventilation, and air conditioning (HVAC) control is a key component of the energy optimization of modern buildings. Generally, the aim of optimal HVAC control is to achieve a balance between minimizing energy use and maximizing the comfort level of the occupants of the building. The comfort level of the occupants may be impacted by the temperature, humidity, and other environmental factors experienced in the building.

The carbon emissions and energy usage goal is input into the energy usage optimizer 320 via a planning model, and the optimizer will deliver setpoint offsets 330 to the individual sites 310 for one or more controlled variables (CVs). The CVs in an HVAC system may include, among other variables, temperature, humidity, and/or ventilation flow rate. The energy usage 340 resultant from the CVs is fed back to the energy usage optimizer in a closed-loop system, and the energy usage optimizer provides the result 350 that corresponds to the goal that was set within a feasible region defined by the constraints of the controlled variables.

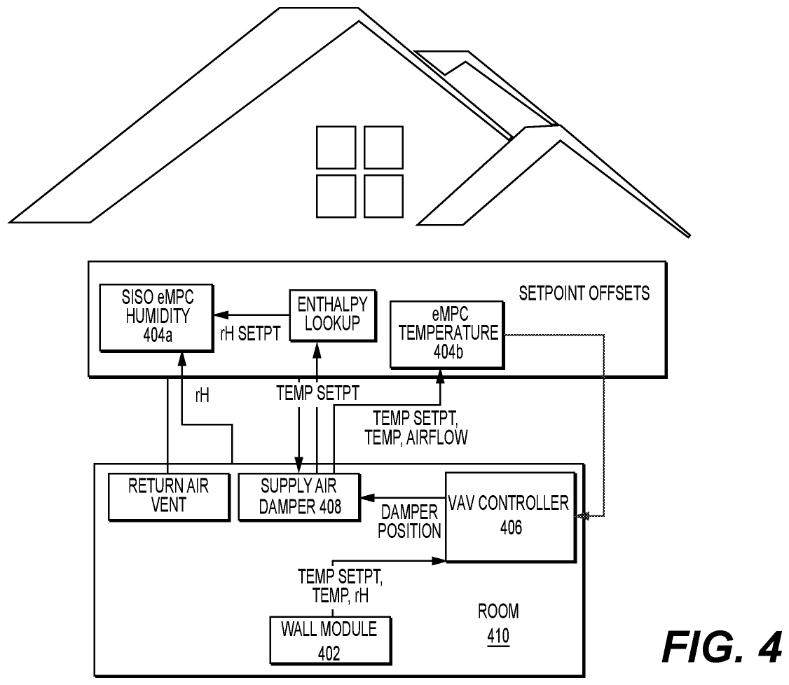

With reference to FIG. 4, the MPC control at a site level will be described in more detail. FIG. 4 provides an exemplary application of the MPC control as applied to a single room 410 of a building, but the principles of the application to the room may be expanded to include multiple rooms, an area of a building, a whole building, or multiple buildings or sites.

In the exemplary application described in FIG. 4, a wall module 402 is provided that allows for a user to provide a temperature and/or humidity setpoint, a preferred ventilation flow rate, and sensors that determine ambient conditions such as temperature and humidity. The setpoint and sensor inputs are provided to a variable air volume (VAV) controller 406 that corresponds to the process controller 206a-206n in FIGS. 2A and 2B in the Purdue model of process control described therein.

The VAV controller 406 itself may be a unit MPC controller, but alternatively may be a legacy controller that uses a control algorithm from one or more unit MPC controllers (e.g., single input single output (SISO) electronic MPC (eMPC) 404a for humidity control and/or eMPC 404b for temperature control) to override the setpoints entered by the user. As discussed above, MPC has the advantage over conventional controls, such as PID controllers, that multiple variables may be controlled simultaneously in a closed loop manner. An MPC model 250 is delivered from the energy usage optimizer 320 in FIG. 3 to each of the unit eMPC controllers 404a and 404b, and the model focuses on the intra-unit dynamic relationships between controlled variables (CVs), manipulated variables (MVs), and disturbance variables (DVs) pertaining to operation of the HVAC system of the room.

In FIG. 4, the CVs include temperature, humidity and volumetric air flow, the MVs include damper position of a supply air damper 408, and DVs include but are not limited to ambient air temperature and humidity. Note that a “controlled variable” (CV) generally denotes a variable whose value is controlled to be at or near a setpoint or within a desired range, while a “manipulated variable” (MV) generally denotes a variable that is adjusted in order to alter the value of at least one controlled variable. A “disturbance variable” (DV) generally denotes a variable whose value can be considered but not controlled or adjusted. The unit MPC controllers 404a and 404b provide the site-wide MPC controller 320 with future predictions and operating constraints for the CVs and MVs of the room to determine a feasible region for use by the VAV controller 402.

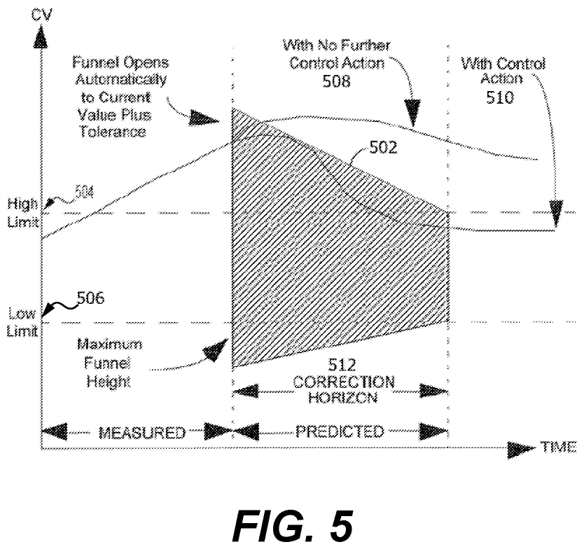

FIG. 5 depicts an example dynamic feasible region for use by an MPC model 250 as described in FIGS. 2A and 2B performing model predictive control according to this disclosure. The MPC model 250 generally operates to predict future values of one or more CVs and make adjustments to one or more MVs so that control objectives determined by a planning model are satisfied. CVs for the present disclosure may include temperature, humidity, and volumetric flow rate for a site or for multiple sites. MVs may include damper position for the damper of an air handling unit. Control objectives for the present disclosure may include a reduction in carbon emissions, a decrease in energy usage, and other objectives.

In general, the MPC model 250 may use a reference trajectory formulation of control error. Control error generally refers to the violation of a specified dynamic feasible region defined by the MPC model 250 and is a mismatch between the value that the MPC model expects a controlled variable to obtain in the future and the actual value that the controlled variable obtains. In some embodiments, the MPC model 250 implements range control that uses a funnel formulation for control error to arrive at a dynamic feasible region.

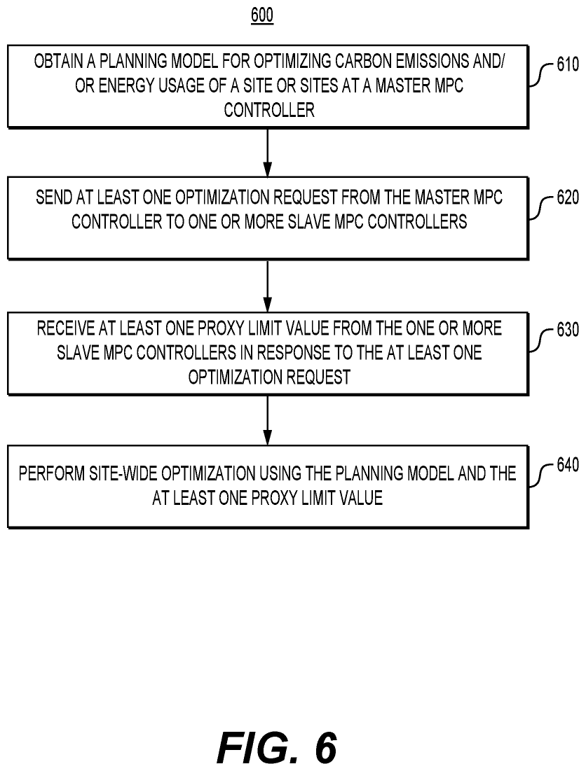

In FIG. 5, a dynamic feasible region (a funnel region 502) defines the reference trajectory region for control error of a variable subject to proxy limits as defined above. This funnel region 502 defines an area where flexibility is provided in meeting control objectives during the initial portion of a proxy limit's trajectory in the funnel region 502. With regard to the present disclosure, a high limit 504 and a low limit 506 is determined as proxy limits for a combination of CVs, such as temperature, humidity, and or volume flow rate, based on a planning model that incorporates at least one control objective, such as a specified carbon emission reduction or a target energy usage. The CVs are measured for a time, and the MPC model predicts future values of the CVs with no further control action taken, shown as line 508 of the proxy limit. The MPC model adjusts the MVs, such as damper position, to manipulate the proxy limits within the feasible region to arrive at line 510 with control action. The correction horizon 512 is the time in which the manipulated variables fall within the limits defined by the planning model. Additional details regarding determining a dynamic feasible region and the equations used to arrive at the funnel region can be found in U.S. Pat. No. 8,046,089 (which is hereby incorporated by reference in its entirety). Further details of the dynamic feasible region will be discussed with respect to FIG. 6.

FIG. 6 depicts a flowchart of an exemplary method 600 for optimizing carbon emissions and/or energy usage of a site using a cascaded MPC architecture 200. For ease of explanation, the method 600 is described with respect to the cascaded MPC architecture 200, which could operate in the control and automation system 100. The method 600 could be used with any other suitable cascaded MPC architecture and in any other suitable system.

As shown in FIG. 6, the method 600 begins at step 610 with obtaining a planning model for optimizing carbon emissions and/or energy usage of the site at a site-wide model predictive control (MPC) controller. A planning model may be constructed from a combination of various sources, such as planning tools, scheduling tools, and/or historical operating data. The planning model includes goals for carbon emissions reduction and energy usage, and may include preferred sources of energy that help determine energy usage preferences.

Once a planning model is available, the method 600 continues at step 620 by sending at least one optimization request from a site-wide MPC controller to one or more unit MPC controllers, wherein the site-wide MPC controller includes an energy optimizer for one or more sites, and the unit MPC controllers correspond to CVs at particular sites as described in FIGS. 3 and 4. Each CV may correspond to its own unit MPC controller, such as one unit MPC controller for temperature, one for humidity, and one for volume flow rate, among other CVs. The optimization request communicates to the unit MPC controllers a request for constraints on the CVs, which includes setpoints for the CVs. The setpoints may be received from a user via a module or may be included in a model residing on the unit MPC controller. The constraints may include a range of acceptable values for the CVs, and a range of possible values for the MVs. The MVs may include, for example, damper position of the HVAC system of a particular site. In order for a site-wide MPC controller 202 to cascade over the unit MPC controllers 204a-204n, the site-wide MPC controller 202 honors the constraints of the unit controllers 204a-204n, or the overall combined solution may not be optimal or feasible to implement.

To help avoid this situation, a proxy limit is used to merge multiscale models. At step 630, the method 600 includes receiving at least one proxy limit value from the one or more unit MPC controllers at the site-wide MPC controller in response to the at least one optimization request, wherein the at least one proxy limit value identifies an extent to which one or more controlled variables controlled by the one or more unit MPC controllers are adjustable without violating one or more controlled variable constraints. A proxy limit is an alternative representation of the unit MPC controllers' constraints. Proxy limits can be viewed as conduits between individual unit MPC controllers and the site-wide MPC controller to “transport” the unit MPC controllers' constraints to the site-wide MPC controller. Proxy limits from multiple unit MPC controllers 204a-204n can be combined and included in the site-wide MPC controller's control and energy use optimization formulations.

For each MV of the site-wide MPC controller 202, each of its downstream unit MPC controllers can predict the amount of distance it could move before one or more unit CVs or MVs would reach their operating limits. When two or more MVs from the site-wide MPC controller 202 are associated with a unit MPC controller 204a-204n, the proxy limits can be multivariate in nature. Additional details regarding the proxy limits in hierarchical MPC control can be found in U.S. Pat. No. 9,722,629 (which is hereby incorporated by reference in its entirety).

In each unit, regardless of how many unit constraints can limit a site-wide MPC controller's MV (such as the damper position), the site-wide MPC controller 202 only needs to know the point where it should stop pushing its MV (otherwise some lower-level constraint violation can result). This stopping point coincides with the proxy limit, which represents the entire set of active unit constraints in the corresponding low-level unit that can limit the site-wide MPC controller's MV.

One feature of proxy limits is that all unit MPC constraints in a unit can be distilled into one or several proxy limits. The proxy limits therefore function as a bonding mechanism for keeping the coarse-scale model 200 intact in the site-wide MPC controller 202 while merging it effectively with the fine-scale unit MPC models 250. In other words, this makes it possible to keep the site-wide optimization problem inside the site-wide MPC controller 202.

At step 640, the method includes performing site-wide optimization at the site-wide MPC controller using the planning model and the at least one proxy limit value. This is achieved with reference to FIG. 5 by changing the manipulated variables within their constraints to maintain the controlled variables, via the proxy limits, in the feasible region defined by the planning model. In the present disclosure, this may include adjusting the damper position of a variable air volume HVAC system to maintain temperature, humidity, and volumetric flow rate within their respective constraints, while meeting the planning models goals for carbon emissions and/or energy usage, among other goals.

Although FIG. 6 illustrates one example of a method 600 for using cascaded MPC controllers in an industrial process control and automation system, various changes may be made to FIG. 6. For example, while shown as a series of steps, various steps in FIG. 6 could overlap, occur in parallel, occur in a different order, or occur any number of times.

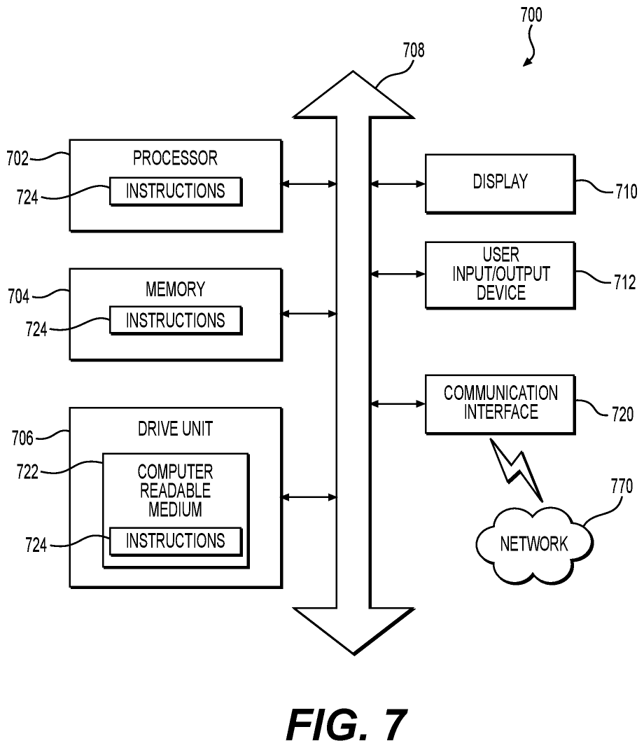

FIG. 7 depicts an implementation of a controller 700 that may execute techniques presented herein, according to one or more embodiments. The controller 700 may include a set of instructions that can be executed to cause the controller 700 to perform any one or more of the methods or computer based functions disclosed herein. The controller 700 may operate as a standalone device or may be connected, e.g., using a network, to other computer systems or peripheral devices.

In a networked deployment, the controller 700 may operate in the capacity of a server or as a client in a server-client user network environment, or as a peer computer system in a peer-to-peer (or distributed) network environment. The controller 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 700 can be implemented using electronic devices that provide voice, video, or data communication. Further, while the controller 700 is illustrated as a single system, the term “system” shall also be taken to include any collection of systems or sub-systems that individually or jointly execute a set, or multiple sets, of instructions to perform one or more computer functions.

As illustrated in FIG. 7, the controller 700 may include a processor 702, e.g., a central processing unit (CPU), a graphics processing unit (GPU), or both. The processor 702 may be a component in a variety of systems. For example, the processor 702 may be part of a standard computer. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The controller 700 may include a memory 704 that can communicate via a bus 708. The memory 704 may be a main memory, a static memory, or a dynamic memory. The memory 704 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 704 includes a cache or random-access memory for the processor 702. In alternative implementations, the memory 704 is separate from the processor 702, such as a cache memory of a processor, the system memory, or other memory. The memory 704 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 704 is operable to store instructions executable by the processor 702. The functions, acts or tasks illustrated in the figures or described herein may be performed by the processor 702 executing the instructions stored in the memory 704. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 700 may further include a display 710, such as a liquid crystal display (LCD), an organic light emitting diode (OLED), a flat panel display, a solid-state display, a cathode ray tube (CRT), a projector, a printer or other now known or later developed display device for outputting determined information. The display 710 may act as an interface for the user to see the functioning of the processor 702, or specifically as an interface with the software stored in the memory 704 or in the drive unit 706.

Additionally or alternatively, the controller 700 may include an input device 712 configured to allow a user to interact with any of the components of controller 700. The input device 712 may be a number pad, a keyboard, or a cursor control device, such as a mouse, or a joystick, touch screen display, remote control, or any other device operative to interact with the controller 700.

The controller 700 may also or alternatively include drive unit 706 implemented as a disk or optical drive. The drive unit 706 may include a computer-readable medium 722 in which one or more sets of instructions 724, e.g. software, can be embedded. Further, the instructions 724 may embody one or more of the methods or logic as described herein. The instructions 724 may reside completely or partially within the memory 704 and/or within the processor 702 during execution by the controller 700. The memory 704 and the processor 702 also may include computer-readable media as discussed above.

In some systems, a computer-readable medium 722 includes instructions 724 or receives and executes instructions 724 responsive to a propagated signal so that a device connected to a network 770 can communicate voice, video, audio, images, or any other data over the network 770. Further, the instructions 724 may be transmitted or received over the network 770 via a communication port or interface 720, and/or using a bus 708. The communication port or interface 720 may be a part of the processor 702 or may be a separate component. The communication port or interface 720 may be created in software or may be a physical connection in hardware. The communication port or interface 720 may be configured to connect with a network 770, external media, the display 710, or any other components in controller 700, or combinations thereof. The connection with the network 770 may be a physical connection, such as a wired Ethernet connection or may be established wirelessly as discussed below. Likewise, the additional connections with other components of the controller 700 may be physical connections or may be established wirelessly. The network 770 may alternatively be directly connected to a bus 708.

While the computer-readable medium 722 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 722 may be non-transitory, and may be tangible.

The computer-readable medium 722 can include a solid-state memory such as a memory card or other package that houses one or more non-volatile read-only memories. The computer-readable medium 722 can be a random-access memory or other volatile re-writable memory. Additionally or alternatively, the computer-readable medium 722 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 700 may be connected to a network 770. The network 770 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 770 may include wide area networks (WAN), such as the Internet, local area networks (LAN), campus area networks, metropolitan area networks, a direct connection such as through a Universal Serial Bus (USB) port, or any other networks that may allow for data communication. The network 770 may be configured to couple one computing device to another computing device to enable communication of data between the devices. The network 770 may generally be enabled to employ any form of machine-readable media for communicating information from one device to another. The network 770 may include communication methods by which information may travel between computing devices. The network 770 may be divided into sub-networks. The sub-networks may allow access to all of the other components connected thereto or the sub-networks may restrict access between the components. The network 770 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

It is to be appreciated that ‘one or more’ includes a function being performed by one element, a function being performed by more than one element, e.g., in a distributed fashion, several functions being performed by one element, several functions being performed by several elements, or any combination of the above.

Moreover, it will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

What is claimed is:

1. A computer-implemented method for optimizing carbon emissions and/or energy usage of a site comprising:
obtaining a planning model for optimizing carbon emissions and/or energy usage of the site at a site-wide model predictive control (MPC) controller;
sending at least one optimization request from the site-wide MPC controller to one or more unit MPC controllers;
receiving at least one proxy limit value from the one or more unit MPC controllers at the site-wide MPC controller in response to the at least one optimization request, wherein the at least one proxy limit value identifies an extent to which one or more controlled variables controlled by the one or more unit MPC controllers are adjustable without violating one or more controlled variable constraints; and
performing site-wide optimization at the site-wide MPC controller using the planning model and the at least one proxy limit value, wherein the one or more controlled variables includes at least one of temperature, humidity, and ventilation flow rate.

2. The method of claim 1, wherein receiving the at least one proxy limit value comprises receiving at least one proxy limit value that is based on one or more MPC models used by the one or more unit MPC controllers.

3. The method of claim 2, wherein the unit MPC controllers control one or more actuators used to control one or more manipulated variables, wherein changes to the one or manipulated variables result in changes to the one or more controlled variables.

4. The method of claim 3, wherein the one or more actuators includes an actuator for adjusting the damper position of an HVAC system.

5. The method of claim 1, wherein each proxy limit value identifies a maximum or minimum value obtainable for one of the one or more controlled variable without violating any controlled variable constraints.

6. The method of claim 1, wherein the site-wide MPC controller during the site-wide optimization generates a real-time planning solution within a closed-loop control system.

7. The method of claim 1, wherein the site includes at least one of a building, a warehouse, and a campus.

8. A system for optimizing carbon emissions and/or energy usage of a site comprising:
a site-wide model predictive control (MPC) controller comprising:
at least one memory configured to store a planning model for an industrial facility;
at least one network interface configured to communicate with one or more unit MPC controllers; and
at least one processing device configured to:
obtain a planning model for optimizing carbon emissions and/or energy usage of the site;
send at least one optimization request to one or more unit MPC controllers;
receive at least one proxy limit value from the one or more unit MPC controllers in response to the at least one optimization request, wherein the at least one proxy limit value identifies an extent to which one or more controlled variables controlled by the one or more unit MPC controllers are adjustable without violating one or more controlled variable constraints; and
perform site-wide optimization using the planning model and the at least one proxy limit value, wherein the one or more controlled variables includes at least one of temperature, humidity, and ventilation flow rate.

9. The system of claim 8, wherein receiving the at least one proxy limit value comprises receiving at least one proxy limit value that is based on one or more MPC models used by the one or more unit MPC controllers.

10. The system of claim 9, wherein the unit MPC controllers control one or more actuators used to control one or more manipulated variables, wherein changes to the one or manipulated variables result in changes to the one or more controlled variables.

11. The system of claim 10, wherein the one or more actuators includes an actuator for adjusting the damper position of an HVAC system.

12. The method of claim 8, wherein each proxy limit value identifies a maximum or minimum value obtainable for one controlled variable without violating any controlled variable constraints.

13. The method of claim 8, wherein the site-wide MPC controller during the site-wide optimization generates a real-time planning solution within a closed-loop control system.

14. The method of claim 8, wherein the site includes at least one of a building, a warehouse, and a campus.

15. A non-transitory computer-readable medium containing instructions for optimizing carbon emissions and/or energy usage of a site, the non-transitory computer-readable medium storing instructions that, when executed by at least one processor, configure the at least one processor for:
obtaining a planning model for optimizing carbon emissions and/or energy usage of the site at a site-wide model predictive control (MPC) controller;
sending at least one optimization request from the site-wide MPC controller to one or more unit MPC controllers;
receiving at least one proxy limit value from the one or more unit MPC controllers at the site-wide MPC controller in response to the at least one optimization request, wherein the at least one proxy limit value identifies an extent to which one or more controlled variables controlled by the one or more unit MPC controllers are adjustable without violating one or more controlled variable constraints; and
performing site-wide optimization at the site-wide MPC controller using the planning model and the at least one proxy limit value, wherein the one or more controlled variables includes at least one of temperature, humidity, and ventilation flow rate.

16. The non-transitory computer-readable medium of claim 15, wherein receiving the at least one proxy limit value comprises receiving at least one proxy limit value that is based on one or more MPC models used by the one or more unit MPC controllers.

17. The non-transitory computer-readable medium of claim 16, wherein the unit MPC controllers control one or more actuators used to control one or more manipulated variables, wherein changes to the one or manipulated variables result in changes to the one or more controlled variables.

18. The non-transitory computer-readable medium of claim 17, wherein the one or more actuators includes an actuator for adjusting the damper position of an HVAC system.

19. The non-transitory computer-readable medium of claim 15, wherein each proxy limit value identifies a maximum or minimum value obtainable for one controlled variable without violating any controlled variable constraints.

20. The non-transitory computer-readable medium of claim 15, wherein the site-wide MPC controller during the site-wide optimization generates a real-time planning solution within a closed-loop control system.
